(19) United States
(12) Patent Application Publication
(10) Pub. No.: US 2025/0300774 A1
(43) Pub. Date: Sep. 25, 2025

(54) FULL SPECTRUM UTILIZATION FOR MIXED WIFI GENERATIONS

(71) Applicant: MaxLinear, Inc., Carlsbad, CA (US)

(72) Inventors: Ziv Avital, Kadima (IL); Avi Avraham Mansour, Givat-Shmuel (IL); Nir Palgy, Rosh Haayin (IL); Nimrod Hershco, Ra’anana (IL); Daniel Keschet, Ein Vered (IL); Amir Rosenblum, Hod Hasharon (IL); Avner Epstein, Givataytim (IL); Oren Kedem, Modii'n-Maccabim-Reut (IL); Rainer Strobel, München (DE)

(73) Assignee: MaxLinear, Inc., Carlsbad, CA (US)

(21) Appl. No.: 19/087,386

(22) Filed: Mar. 21, 2025

Related U.S. Application Data
(60) Provisional application No. 63/568,415, filed on Mar. 21, 2024.

(51) Int. Cl. H04L 5/00

(52) U.S. Cl. CPC H04L 5/0005; H04L 5/0098

(57) ABSTRACT

An access point (AP) may include a processing device. The processing device may send, from the AP to a first-generation station (STA), a first generation beacon in a first duration in a first subset of a first frequency segment. The processing device may send, from the AP to a second-generation STA, a second generation beacon in the first duration in a second subset of a second frequency segment. The processing device may receive, at the AP from the first-generation (STA), a first single user packet in a second duration in the first frequency segment. The processing device may receive, at the AP from the second-generation STA, a second single user packet in a third duration in the second frequency segment.

### RELATED APPLICATION

This application claims the benefit of U.S. Provisional Application No. 63/568,415, filed Mar. 21, 2024, the disclosure of which is incorporated herein by reference in its entirety for all purposes.

This disclosure relates to wireless technology, and more specifically, to maximizing spectrum utilization for mixed Wi-Fi® generations.

### BACKGROUND

Unless otherwise indicated herein, the materials described herein are not prior

art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as Institute of Electrical and Electronics Engineers (IEEE) 802.11a, IEEE 802.11b, IEEE 802.11g, IEEE 802.11n (Wi-Fi® 4), IEEE 802.11ac (Wi-Fi® 5), IEEE 802.11ax (Wi-Fi® 6), IEEE 802.11be (Wi-Fi® 7), and so forth.

The subject matter claimed in the present disclosure is not limited to implementations that solve any disadvantages or that operate only in environments such as those described above. Rather, this background is only provided to illustrate one example technology area where some examples described in the present disclosure may be practiced.

### SUMMARY

An access point (AP) may include a processing device. The processing device may send, from the AP to a first-generation station (STA), a first generation beacon in a first duration in a first subset of a first frequency segment. The processing device may send, from the AP to a second-generation STA, a second generation beacon in the first duration in a second subset of a second frequency segment. The processing device may receive, at the AP from the first-generation (STA), a first single user packet in a second duration in the first frequency segment. The processing device may receive, at the AP from the second-generation STA, a second single user packet in a third duration in the second frequency segment.

An AP may include a processing device. The processing device may send, from the AP to a first generation station (STA), one or more first-generation downlink orthogonal frequency-division multiple access (OFDMA) packets in a first duration in a lower frequency segment. The processing device may send, from the AP to a second generation

STA, one or more second-generation downlink OFDMA packets in the first duration in an upper frequency segment.

A method may include one or more of: sending, from an access point (AP to a first-generation station (STA), a first generation beacon in a first duration in a first subset of a first frequency segment; sending, from the AP to a second-generation STA, a second generation beacon in the first duration in a second subset of a second frequency segment; receiving, at the AP from the first-generation (STA), a first single user packet in a second duration in the first frequency segment; and receiving, at the AP from the second-generation STA, a second single user packet in a third duration in the second frequency segment.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example of spectrum usage for different STA generations.

FIG. 2 illustrates example association performed using single-user associations for different STA generations.

FIG. 3 illustrates example data downlink/uplink performed using orthogonal frequency division multiple access (OFDMA) in parallel synchronized.

FIG. 4 illustrates an example process flow for spectrum utilization for mixed

wireless local area network (WLAN) generations.

FIG. 5 illustrates an example process flow for spectrum utilization for mixed WLAN generations.

FIG. 6 illustrates a block diagram of an example system for spectrum utilization for mixed WLAN generations.

FIG. 7 illustrates a diagrammatic representation of a machine in the example form of a computing device within which a set of instructions, for causing the machine to perform any one or more of the methods discussed herein, may be executed.

### DESCRIPTION

Wi-Fi® communications may occur in multiple frequency bands, including the 2.4 GHz, 5 GHZ, and 6 GHz frequency bands. Additionally, some Wi-Fi® communications may be broadcast over different radio links that may include varying operating frequencies.

Access points (AP) in the market may communicate with and/or service more than one generation of user devices or stations (STA). For the Institute of Electrical and Electronics Engineers (IEEE) 802.11be (Wi-Fi® 8) standard, APs may support prior generations (e.g., Wi-Fi® 7, Wi-Fi®6, Wi-Fi® 5, etc.) legacy STAs. The different generations may be served on a time division method and the spectrum may not be utilized fully and may be likewise not optimized or maximized.

The AP may not use the maximal available spectrum because of STAs that support lower bandwidth (for example 6 GHz band using 320 MHz channel and stations supporting 160 MHz or 80 MHz channels). In the IEEE 802.11ax standard, there may be an optional mechanism in the standard known as subchannel selective transmission (SST) to allow moving stations to other frequency bands (beside the primary band). This mechanism was not implemented by many known stations (because the mechanism is an optional feature) and was not part of the Wi-Fi Alliance tests (for interoperability between different companies). Therefore, STAs may not support the SST optional protocol that may allow STAs to move to higher bandwidths (BW). A STA may operate in the upper 160 MHz segment out of the 320 MHz channel when the STA supports 320 MHz bandwidth (without using SST). Without SST, the APs may not maximize backwards compatibility for legacy STAs.

Moreover, packet aggregation for multiple generations is not part of the IEEE 802.11ax and IEEE 802.11be standard. Therefore, multiple generations of stations may not be served at the same time (packet).

IEEE 802.11bn is proposing dynamic subband operation (DSO) that will allow the AP to move stations to other frequency bands (above the one that they support). DSO may include IEEE 802.11bn (WiFi-8) STAs but will not support any legacy stations. Thus, the current solutions will leave millions of existing devices incapable of being able to fully operate on next-generation technology.

Aspects of the present disclosure address this by providing examples to enhance spectrum utilization for mixed Wi-Fi generations. In an example, an AP may imitate a few separated basic service sets (BSSs), per 80 or 160 Mhz frequency segment. The AP may transmit, at the same time, a few different beacons in the frequency segments for different generations, for example, IEEE 802.11ax in lower 160 MHz and IEEE 802.11be/bn at higher 160 MHz. The frequency segments (e.g., different BSS) may associate the same bandwidth and/or generation of stations using single-user (SU) packets. The transmit and receive may not necessarily be in parallel at both bands/BSS because the AP receiver may not be able to decode uplink SU parallel packets.

For data transfer, the AP may use downlink orthogonal frequency-division multiple access (OFDMA) multiuser packets and uplink trigger based multiuser OFDMA packets. The frequency segments (e.g., BSSs) may use a different packet type (which may be specific to or dependent on the related generation) and may be synchronized in length of the preambles and length of the data.

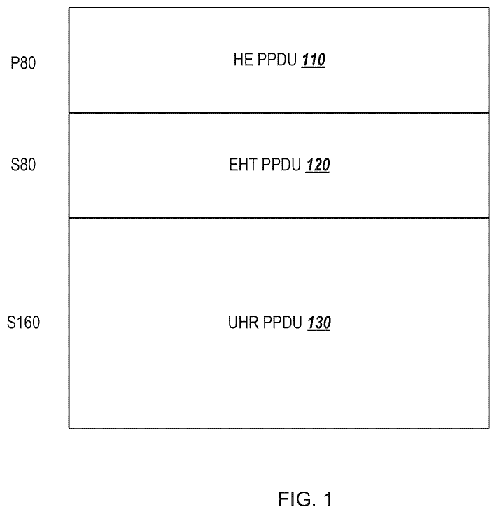

This approach allows utilization of the spectrum, as illustrated in FIG. 1. For example, a primary channel (P80) may use 80 MHz and may use high efficiency (HE) physical layer protocol data units (PPDU) 110. A secondary channel (S80) may use 80 MHz and may use extremely high throughput (EHT) PPDU 120. A secondary channel (S160) may use 160 MHz and may use ultra high reliability (UHR) PPDU 130. The HE PPDU 110 on P80, the EHT PPDU 120 on S80, and the UHR PPDU 130 on S160 may be aligned in the preamble length and the data length.

Further advantages of the present disclosure include increased and/or full use of spectrum (e.g., x2 or x4 compared to 80 Mhz or 160 Mhz stations), without using SST support, without legacy STA supporting 320/160 MHz for the higher segment, low latency, among other benefits.

An access point may communicate with stations from different generations so that full usage of the spectrum may be facilitated. The different generations of stations may include stations that may communicate using different standards such as IEEE 802.11, IEEE 802.11b, IEEE 802.11a, IEEE 802.11g, IEEE 802.11n, IEEE 802.11ac, IEEE 802.11ax, IEEE 802.11be, IEEE 802.11bn, the like, or a combination thereof. For purposes of this disclosure, examples will be provided with respect to IEEE 802.11ax, IEEE 802.11bn, and IEEE 802.11bn; however, these examples are not limiting.

The AP may include a processing device. The processing device may send,

from the AP to a first-generation STA, a first generation beacon in a first duration in a first subset of a first frequency segment. The processing device may send, from the AP to a second-generation STA, a second generation beacon in the first duration in a second subset of a second frequency segment.

The first-generation STA may be any STA that may communicate using the different standards (e.g., IEEE 802.11, IEEE 802.11b, IEEE 802.11a, IEEE 802.11g, IEEE 802.11n, IEEE 802.11ac, IEEE 802.11ax, IEEE 802.11be, IEEE 802.11bn, the like, or a combination thereof) disclosed herein. The second-generation STA may be any STA that may communicate using the different standards (e.g., IEEE 802.11, IEEE 802.11b, IEEE 802.11a, IEEE 802.11g, IEEE 802.11n, IEEE 802.11ac, IEEE 802.11ax, IEEE 802.11be, IEEE 802.11bn, the like, or a combination thereof) disclosed herein in which the standard is different from the standard used by the first generation STA.

The first generation beacon may be a beacon communicated by a standard used by the first-generation STA and the second generation beacon may be a beacon communicated by a standard used by the second-generation STA. The first-generation beacon and the second-generation beacon may be communicated in the same duration (e.g., a first duration). According to some examples, to imitate a few different BSSs per frequency segment (e.g., 80 or 160 MHz bandwidth), the AP may transmit at the same time multiple different beacons in the frequency segments for different generations. For example, the AP may transmit using IEEE 802.11ax in the lower 160 MHz and IEEE 802.11be/bn at the higher 160 MHz.

The first duration may be e.g., a duration used to send one or more of a beacon, a single user association, a clear-to-send (CTS) to self, a downlink OFDMA packet, an uplink OFDMA packet, a trigger frame for an uplink OFDMA packet, the like, or a combination thereof.

The first frequency segment and/or the second frequency segment may be a suitable wireless local area network (WLAN) frequency channel in the 2.4 GHz frequency band, the 5 GHz frequency band, the 6 GHz frequency band, or the like.

In one example, the first frequency segment and/or the second frequency segment may be in the 5 GHz frequency band. In one example, the first frequency segment and/or the second frequency segment may have a bandwidth of 80 MHz in the 5 GHz frequency band. The first frequency segment and/or the second frequency segment may be one or more of e.g., channel 42 (i.e., 5170 MHz to 5250 MHz), channel 58 (i.e., 5250 MHz to 5330 MHz), channel 106 (i.e., 5490 MHz to 5570 MHz), channel 122 (i.e., 5570 MHz to 5650 MHZ), channel 138 (i.e., 5650 MHz to 5730 MHz), channel 155 (i.e., 5735 MHz to 5815 MHz), channel 171 (5815 MHz to 5895 MHz), the like, or a combination thereof. Although channels including 80 MHz of bandwidth have been provided, any suitable channel bandwidth may be used.

In one example, the first frequency segment and/or the second frequency segment may have a bandwidth of 160 MHz in the 5 GHz frequency band. The first frequency segment and/or the second frequency segment may be e.g., channel 50 (i.e., 5170 MHz to 5330 MHz). The first frequency segment and/or the second frequency segment may be e.g., channel 114 (i.e., 5490 MHz to 5650 MHZ). The first frequency segment and/or the second frequency segment may be channel 163 (i.e., 5735 MHz to 5895 MHz).

Although channels including 160 MHz of bandwidth have been provided, any suitable channel bandwidth may be used.

In one example, the first frequency segment and/or the second frequency segment may have a bandwidth of 160 MHz in the 6 GHz frequency band. The first frequency segment and/or the second frequency segment may be one or more of e.g., channel 15 (i.e., 5945 MHz to 6105 MHz), channel 47 (6105 MHz to 6265 MHz), channel 79 (i.e., 6265 MHz to 6425 MHz), channel 111 (i.e., 6425 MHz to 6585 MHz), channel 143 (i.e., 6585 MHz to 6745 MHZ), channel 175 (i.e., 6745 MHz to 6905 MHz), channel 207 (i.e., 6905 MHz to 7065 MHz), the like, or a combination thereof. Although channels including 160 MHz of bandwidth have been provided, any suitable channel bandwidth may be used.

In another example, the first frequency segment and/or the second frequency segment may have a bandwidth of 320 MHz in the 6 GHz frequency band. The first frequency segment and/or the second frequency segment may be e.g., channel 31 (i.e., 5945 MHz to 6265 MHz). The first frequency segment and/or the second frequency segment may be e.g., channel 95 (i.e., 6265 MHz to 6585 MHz). The first frequency segment and/or the second frequency segment may be e.g., channel 159 (i.e., 6585 MHz to 6905 MHz). The first frequency segment and/or the second frequency segment may be e.g., channel 63 (i.e., 6105 MHz to 6425 MHz). The first frequency segment and/or the second frequency segment may be e.g., channel 127 (i.e., 6425 MHz to 6745 MHz). The first frequency segment and/or the second frequency segment may be channel 191 (i.e., 6745 MHz to 7065 MHz). Although channels including 320 MHz of bandwidth have been provided, any suitable channel bandwidth may be used.

The first subset of the first frequency segment and/or the second subset of the second frequency segment may be any subset that is suitable to send the beacon to the first generation STA and/or the second generation STA. For example, the first subset may have a 20 MHz bandwidth in the first frequency segment and/or the second subset may have a 20 MHz bandwidth in the second frequency segment.

The processing device may receive, at the AP from the first-generation STA, a first single user (SU) packet in a second duration in the first frequency segment. The processing device may receive, at the AP from the second-generation STA, a second SU packet in a third duration in the second frequency segment. The first SU packet and the second SU packet may be received in different time durations (e.g., in which the time durations do not overlap) because the AP may not decode uplink SU packets in parallel.

The processing device may associate, at the AP, the first generation STA to the first frequency segment, and/or associate, at the AP, the second generation STA to the second frequency segment. In some examples, the first frequency segment may associate IEEE 802.11ax stations, and/or the second frequency segment may associate IEEE 802.11be/bn stations using single-user (SU) packets with one segment at a time.

Because the AP may not decode multiple SU packets in parallel, to avoid collisions on the unused band, the AP may transmit CTS to self or other packets on the unused band to avoid collisions on the unused band (e.g., from other STAs transmitting SU uplink). The processing device may send, from the AP to the AP, a CTS to self packet in the second duration in a third subset of the second frequency segment. The processing device may send, from the AP to the AP, a CTS to self packet in the third duration in a fourth subset of the first frequency segment. The third duration may be a duration that is suitable to send the CTS-to-self packet in a frequency segment when an SU packet is being sent in a different frequency segment.

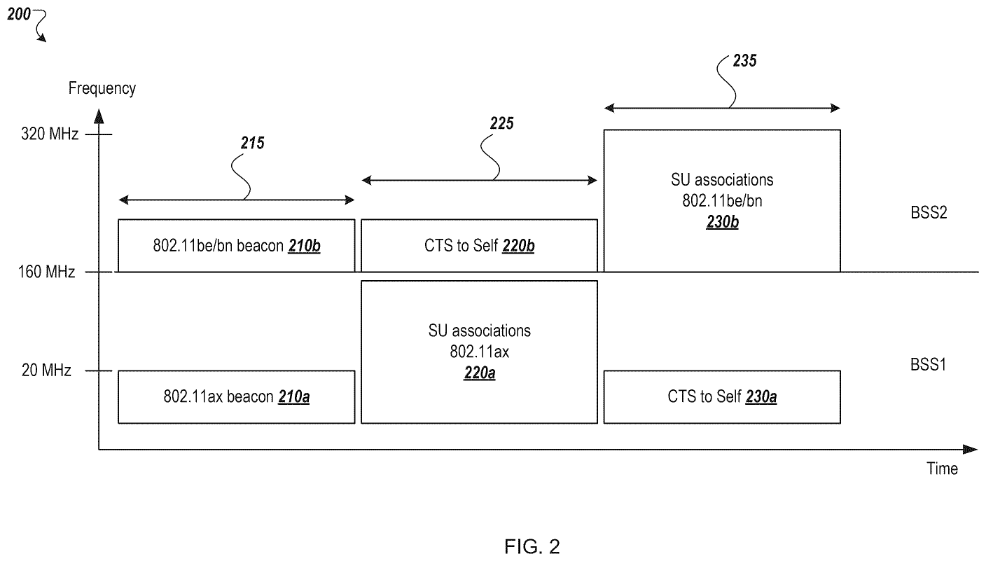

As illustrated in the graph 200 in FIG. 2, an AP may transmit beacons and/or receive SU associations, and/or transmit CTS-to-self in different generations. The graph shows the frequency vs. time for association performed using SU for the frequency segments.

The AP may transmit different beacons in the same time period to different generation STAs. For example, the AP may transmit a first generation beacon (e.g., IEEE 802.11ax beacon 210a) in the first duration 215 in a first subset (e.g., 20 MHz) of a first frequency segment (e.g., a lower frequency segment having a range of 160 MHz). The AP may transmit a second generation beacon (e.g., IEEE 802.11be/bn beacon 210b) in the first duration 215 in a second subset (e.g., a 20 MHz frequency range that differs from the first subset) of a second frequency segment (e.g., an upper frequency segment having a range of 160 MHz that may adjoin the first frequency segment).

The AP may receive SU associations and transmit CTS-to-self in the same time period to different generation STAs. For example, the AP may receive a first SU packet (e.g., IEEE 802.11ax 220a) in the second duration 225 in the first frequency segment (e.g., the lower frequency segment having a range of 160 MHZ). The AP may transmit a CTS-to-self 220b in the second duration 225 in a second subset (e.g., a 20 MHz frequency range that differs from the first subset) or a second frequency segment (e.g., an upper frequency segment having a range of 160 MHz that may adjoin the first frequency segment).

The AP may receive an additional SU association and transmit an additional CTS-to-self in the same time period to different generation STAs. For example, the AP may receive a second SU packet (e.g., IEEE 802.11be/bn 230b) in the third duration 235 in the second frequency segment (e.g., the upper frequency segment having a range of 160 MHz). The AP may transmit a CTS-to-self 230a in the third duration 235 in the first subset (e.g., 20 MHz) of the first frequency segment (e.g., a lower frequency segment having a range of 160 MHz).

The first frequency segment (e.g., the lower frequency segment having a range of 160 MHz) may be associated with a BSS1 and the second frequency segment (e.g., the upper frequency segment having a range of 160 MHz) may be associated with a BSS2. The BSS1 and the BSS2 may facilitate the imitation of different APs (e.g., BSS1 and BSS2) using the same AP.

When the AP has transmitted beacons to different generations of STAs and has associated the different generations of STAs to different frequency segments, the AP may, in addition or alternatively, send data in the first frequency segment and/or the second frequency segment.

The processing device may send the first-generation downlink OFDMA packets and the second-generation downlink OFDMA packets in the same duration and in different frequency segments. The processing device may send, from the AP to the first generation STA, one or more first-generation downlink OFDMA packets in a fourth duration in the first frequency segment. The processing device may send, from the AP to the second generation STA, one or more second-generation downlink OFDMA packets in the fourth duration in the second frequency segment.

The processing device may receive the first-generation uplink OFDMA packets and the second-generation uplink OFDMA packets in the same duration in different frequency segments. The AP may receive data from different generations of STAs that may be associated with different frequency segments. The processing device may receive, at the AP from the first generation STA, one or more first generation uplink OFDMA packets in a fifth duration in the first frequency segment. The processing device may receive, at the AP from the second generation STA, one or more second generation uplink OFDMA packets in a fifth duration in the second frequency segment.

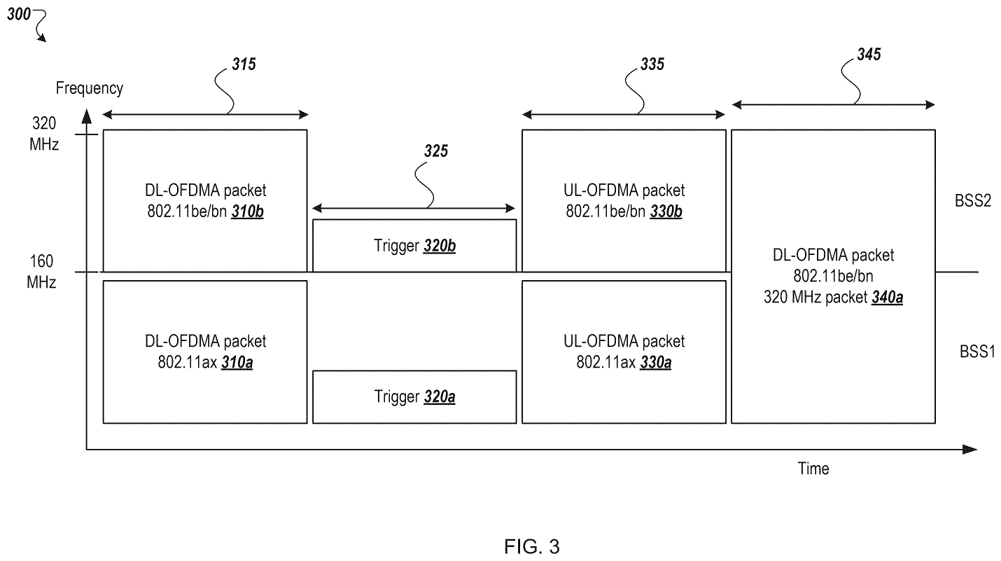

As illustrated in the graph 300 in FIG. 3, an AP may transmit downlink (DL)-OFDMA packets and/or transmit trigger packets and/or receive uplink (UL)-OFDMA packets in different generations. The graph shows the frequency vs. time for data DL/UL performed using OFDMA in parallel for synchronized packets.

The AP may transmit DL-OFDMA packets in the same time period to different generation STAs. The AP may transmit a DL OFDMA packet (e.g., DL-OFDMA packet IEEE 802.11ax 310a) in a fourth duration 315 in a first frequency segment (e.g., a lower-160 MHz bandwidth). The AP may transmit a DL-OFDMA packet (e.g., DL-OFDMA packet IEEE 802.11be/bn 310b) in the fourth duration 315 in the second frequency segment (e.g., an upper 160 Mhz bandwidth).

The AP may receive UL-OFDMA packets in the same time period from different generation STAs. The AP may transmit trigger frames 320a and 320b in time duration 325. After transmitting trigger frames 320a and 320b, the AP may receive uplink OFDMA packets in a fifth duration 335. That is, the AP may receive UL-OFDMA packet IEEE 802.11ax 330a in fifth duration 335 in the first frequency segment (e.g., lower 160 Mhz bandwidth) and may receive OFDMA packet IEEE 802.11 be/bn 330b in fifth duration 335 in the second frequency segment (e.g., upper 160 Mhz bandwidth).

In a different time period 345, the processing device may send, from the AP to the second generation STA, one or more second-generation downlink OFDMA packets in a sixth duration in the first frequency segment and the second frequency segment. The AP may transmit or receive a packet that may include the first frequency segment (e.g., lower 160 Mhz bandwidth) and a second frequency segment (e.g., upper 160 Mhz bandwidth). The packet may be DL-OFDMA IEEE 802.11 be/bn 320 MHz packet 340a. Alternatively or in addition, the packet may be UL-OFDMA IEEE 802.11 be/bn 320 MHz packet.

The different frequency segments may have various characteristics. For example, the first subset of the first frequency segment may be a 20 MHz frequency channel. The second subset of the second frequency segment may be a 20 MHz frequency channel. The first frequency segment may be a lower 160 MHz frequency channel. The second frequency segment may be an upper 160 MHz frequency channel.

The STAs may be from different generations. For example, the first-generation STA may be an IEEE 802.11ax station, and the second generation STA may be one or more of an IEEE 802.11be station or an IEEE 802.11bn station. Although the first-generation has been illustrated as an IEEE 802.11ax station and the second-generation has been illustrated as an IEEE 802.11be/bn station, other combinations of generations may be possible.

Data transfer may be done using downlink OFDMA packets (e.g., using downlink OFDMA multiuser packets) and uplink OFDMA packets (e.g., using trigger based multiuser OFDMA packets). The first frequency segment and/or second frequency segment may have different packet types and synchronized length preambles (e.g., so the 1x and 4x symbols may be aligned in time). The first frequency segment and/or the second frequency segment may have different packet types with synchronized data lengths.

Therefore, the different downlink OFDMA packets may be aligned for the different generation types. One or more first-generation downlink OFDMA packets preamble lengths may be synchronized with one or more second generation downlink OFDMA packets preamble lengths. One or more first-generation downlink OFDMA packets data lengths may be synchronized with one or more second generation downlink OFDMA packets data lengths.

In addition or alternatively, the different uplink OFDMA packets may be aligned for the different generation types. One or more first-generation uplink OFDMA packets preamble lengths may be synchronized with one or more second generation uplink OFDMA packets preamble lengths. One or more first-generation uplink OFDMA packets data lengths may be synchronized with one or more second generation uplink OFDMA packets data lengths.

The OFDMA preambles and symbol duration may be aligned in various ways. For example, an extremely high throughput (EHT) preamble and/or symbol duration may be aligned with a high efficiency (HE) preamble and/or symbol duration. That is, the PPDUs for EHT and HE may be aligned. For example, an EHT multi user (MU) PPDU may be aligned with an HE MU PPDU. In addition or alternatively, the EHT trigger based (TB) PPDU may be aligned with the HE TB PPDU. Because EHT is associated with IEEE 802.11be and HE is associated with IEEE 802.11ax, aligning the preambles and/or data lengths for EHT and HE may include aligning the preambles and/or data lengths for a first generation (e.g., IEEE 802.11ax; HE) with a second generation (e.g., IEEE 802.11be; EHT).

Other generations of preambles and data lengths may be aligned. For example, preambles and/or data lengths using IEEE 802.11bn may be aligned with preambles and/or data lengths using IEEE 802.11be and/or IEEE 802.11ax. Ultra high reliability (UHR), associated with IEEE 802.11bn, may be aligned with EHT. That is, the preambles and data lengths for UHR PPDUs may be aligned with the preambles and data lengths for EHT PPDUs.

The AP may align the preambles and data lengths for different generations of STAs using explicit signaling. For example, fields such as “Number of EHT-SIG symbols,” “Number of EHT-LTF symbols,” and/or “GI+LTF size” may be used to align the preambles and/or data lengths, in which “EHT-SIG” refers to “EHT signal field,” “LTF” refers to long training field,” and “GI” refers to guard interval.

In some examples, SIG design (e.g., for universal signal field (U-SIG), EHT-SIG, UHR-SIG, or the like) may support frequency domain multiplexing of different PPDUs. For the U-SIG, EHT-SIG, and the UHR-SIG, frequency domain multiplexing may be facilitated by using 80 MHz frequency granularity. For HE PPDUs, the frequency granularity may be 160 MHz so that the HE STA does not decode a wrong L length (e.g., non-high throughput (HT) short training field (L-STF), non-HT long training field (L-LTF), non-HT signal field (L-SIG), or the like). There may not be a restriction involving multiplexing EHT with EHT when 80 MHz frequency granularity is used.

There may be various medium access control (MAC) layer adaptations that may occur. For example, trigger frame design may support frequency domain multiplexing of different PPDUs. In some examples, a scheduler may combine STAs from the same generation and/or bandwidth in the same resource unit (RU).

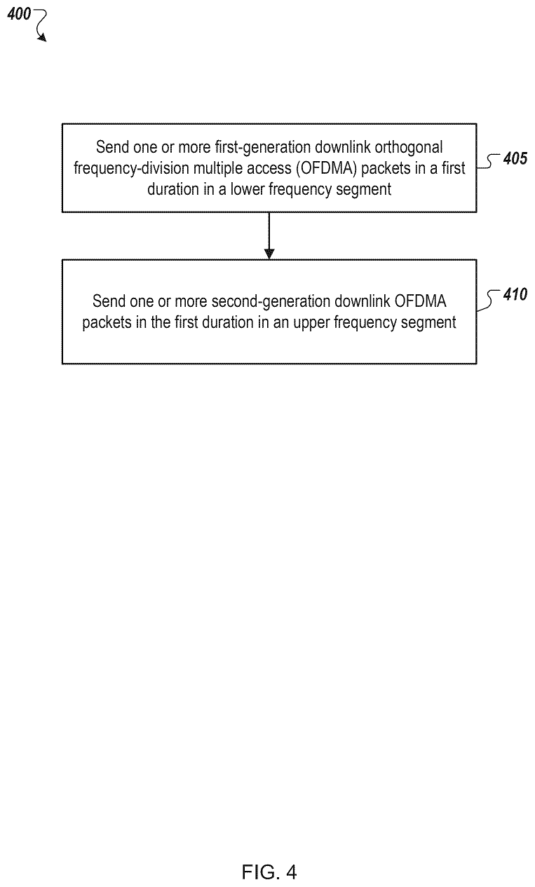

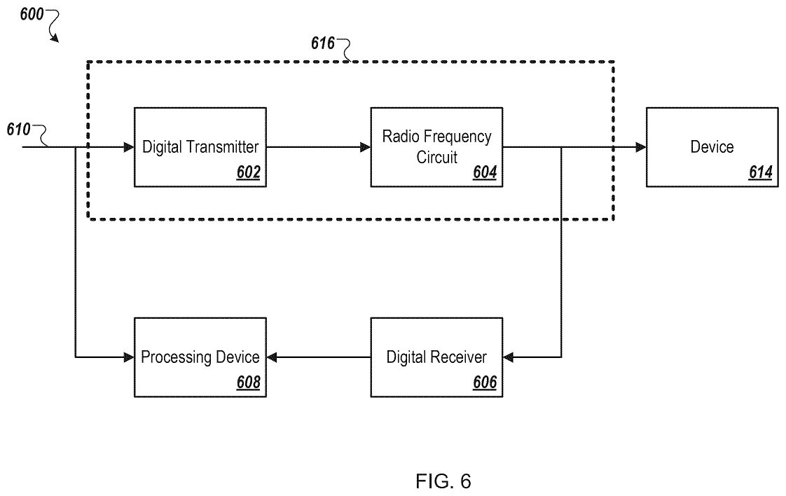

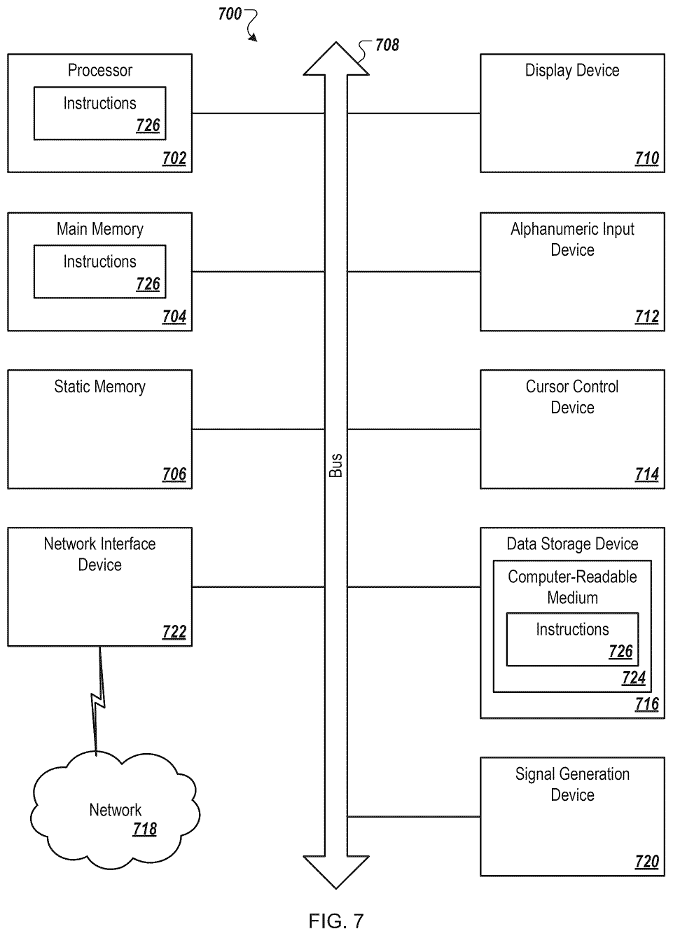

FIG. 4 illustrates a process flow of an example method 400 of spectrum utilization for mixed WLAN generations, in accordance with at least one example described in the present disclosure. The method 400 may be arranged in accordance with at least one example described in the present disclosure. The method 400 may be performed by processing logic that may include hardware (circuitry, dedicated logic, etc.), software (such as is run on a computer system or a dedicated machine), or a combination of both, which processing logic may be included in the processor (e.g., the processing device 702 of FIG. 7), the communication system 600 of FIG. 6, or another device, combination of devices, or systems.

The method 400 may begin at block 405 where the processing logic may send, from the AP to a first generation STA, one or more first-generation downlink OFDMA packets in a first duration in a lower frequency segment. The processing logic may send, from the AP to a second generation STA, one or more second-generation downlink OFDMA packets in the first duration in an upper frequency segment, as shown in block 410.

Modifications, additions, or omissions may be made to the method 400 without departing from the scope of the present disclosure. For example, in some examples, the method 400 may include any number of other components that may not be explicitly illustrated or described.

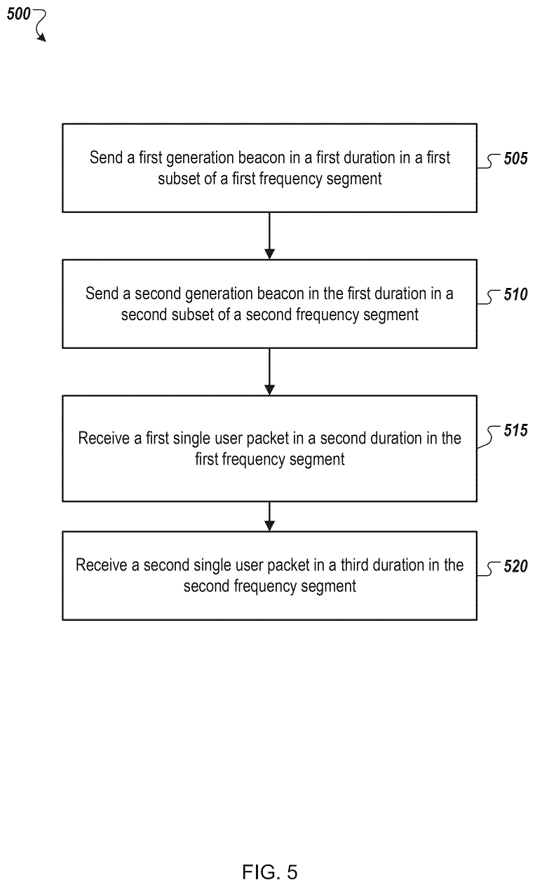

FIG. 5 illustrates a process flow of an example method 500 of spectrum utilization for mixed WLAN generations, in accordance with at least one example described in the present disclosure. The method 500 may be arranged in accordance with at least one example described in the present disclosure. The method 500 may be performed by processing logic that may include hardware (circuitry, dedicated logic, etc.), software (such as is run on a computer system or a dedicated machine), or a combination of both, which processing logic may be included in the processor (e.g., the processing device 702 of FIG. 7), the communication system 600 of FIG. 6, or another device, combination of devices, or systems.

The method 500 may begin at block 505 where the processing logic may send, from an AP to a first-generation STA, a first generation beacon in a first duration in a first subset of a first frequency segment. At block 510, the processing logic may send, from the AP to a second-generation STA, a second generation beacon in the first duration in a second subset of a second frequency segment. At block 515, the processing logic may receive, at the AP from the first-generation (STA), a first single user packet in a second duration in the first frequency segment. At block 520, the processing logic may receive, at the AP from the second-generation STA, a second single user packet in a third duration in the second frequency segment.

Modifications, additions, or omissions may be made to the method 500 without departing from the scope of the present disclosure. For example, in some examples, the method 500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 configured for spectrum utilization for mixed WLAN generations, in accordance with at least one example described in the present disclosure. The communication system 600 may include a digital transmitter 602, a radio frequency circuit 604, a device 614, a digital receiver 606, and a processing device 608. The digital receiver 606 and the processing device may be configured to receive a baseband signal via connection 610. A transceiver 616 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 616 may be communicatively coupled to the device 614.

In some examples, the transceiver 616 may be configured to obtain a baseband signal. For example, as described herein, the transceiver 616 may be configured to generate a baseband signal and/or receive a baseband signal from another device. In some examples, the transceiver 616 may be configured to transmit the baseband signal. For example, upon obtaining the baseband signal, the transceiver 616 may be configured to transmit the baseband signal to a separate device, such as the device 614. Alternatively, or additionally, the transceiver 616 may be configured to modify, condition, and/or transform the baseband signal in advance of transmitting the baseband signal. For example, the transceiver 616 may include a quadrature up-converter and/or a digital to analog converter (DAC) that may be configured to modify the baseband signal. Alternatively, or additionally, the transceiver 616 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 616 may include one or more subcomponents that may be used in preparing the baseband signal and/or transmitting the baseband signal. For example, the transceiver 616 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 604) of the transceiver 616 may be synchronized with the resource controller via the S-plane device, which may contribute to high-accuracy timing with respect to a reference clock.

In some examples, the transceiver 616 may be configured to obtain the baseband signal for transmission. For example, the transceiver 616 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 616 may be configured to generate a baseband signal for transmission. In these and other examples, the transceiver 616 may be configured to transmit the baseband signal to another device, such as the device 614.

In some examples, the transceiver 616 may be configured to receive a transmission from the device 614. In some examples, the transceiver 616 may be configured to transmit a baseband signal to the device 614.

In some examples, the radio frequency circuit 604 may be configured to transmit the digital signal received from the digital transmitter 602. In some examples, the radio frequency circuit 604 may be configured to transmit the digital signal to the device 614 and/or the digital receiver 606. In some examples, the digital receiver 618 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 616. In instances in which the processing device 608 is a standalone device or system, the processing device 608 may be configured to communicate with additional devices and/or systems remote from the processing device 608, such as the transceiver 616 and/or the device 614. For example, the processing device 608 may be configured to send and/or receive transmissions from the transceiver 616 and/or the device 614. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
send, from the AP to a first-generation station (STA), a first generation beacon in a first duration in a first subset of a first frequency segment;
send, from the AP to a second-generation STA, a second generation beacon in the first duration in a second subset of a second frequency segment;
receive, at the AP from the first-generation (STA), a first single user packet in a second duration in the first frequency segment; and
receive, at the AP from the second-generation STA, a second single user packet in a third duration in the second frequency segment.

2. The access point of claim 1, wherein the processing device is further operable to:
associate, at the AP, the first generation STA to the first frequency segment; and
associate, at the AP, the second generation STA to the second frequency segment.

3. The access point of claim 1, wherein the processing device is further operable to:
send, from the AP to the AP, a clear-to-send (CTS) to self packet in the second duration in a third subset of the second frequency segment; and
send, from the AP to the AP, a CTS to self packet in the third duration in a fourth subset of the first frequency segment.

4. The access point of claim 1, wherein the processing device is further operable to:
send, from the AP to the first generation STA, one or more first-generation downlink orthogonal frequency-division multiple access (OFDMA) packets in a fourth duration in the first frequency segment; and
send, from the AP to the second generation STA, one or more second-generation downlink OFDMA packets in the fourth duration in the second frequency segment.

5. The access point of claim 4, wherein:
one or more first-generation downlink OFDMA packets preamble lengths are synchronized with one or more second generation downlink OFDMA packets preamble lengths; and
one or more first-generation downlink OFDMA packets data lengths are synchronized with one or more second generation downlink OFDMA packets data lengths.

6. The access point of claim 1, wherein the processing device is further operable to:
receive, at the AP from the first generation STA, one or more first generation uplink orthogonal frequency-division multiple access (OFDMA) packets in a fifth duration in the first frequency segment; and
receive, at the AP from the second generation STA, one or more second generation uplink OFDMA packets in a fifth duration in the second frequency segment.

7. The access point of claim 6, wherein:
one or more first-generation uplink OFDMA packets preamble lengths are synchronized with one or more second generation uplink OFDMA packets preamble lengths; and
one or more first-generation uplink OFDMA packets data lengths are synchronized with one or more second generation uplink OFDMA packets data lengths.

8. The access point of claim 1, wherein the processing device is further operable to:
send, from the AP to the second generation STA, one or more second-generation downlink OFDMA packets in a sixth duration in the first frequency segment and the second frequency segment.

9. The access point of claim 1, wherein:
the first subset of the first frequency segment is a 20 MHz frequency band;
the second subset of the second frequency segment is a 20 MHz frequency band;
the first frequency segment is a lower 160 MHz frequency band; and
the second frequency segment is an upper 160 MHz frequency band.

10. The access point of claim 1. wherein:
the first-generation STA is an Institute of Electrical and Electronics Engineers (IEEE) 802.11ax station; and
the second-generation STA is one or more of an IEEE 802.11be station or an IEEE 802.11bn station.

11. An access point (AP), comprising:
a processing device operable to:
send, from the AP to a first generation station (STA), one or more first-generation downlink orthogonal frequency-division multiple access (OFDMA) packets in a first duration in a lower frequency segment; and
send, from the AP to a second generation STA, one or more second-generation downlink OFDMA packets in the first duration in an upper frequency segment.

12. The access point of claim 11, wherein:
one or more first-generation downlink OFDMA packets data lengths are synchronized with one or more second generation downlink OFDMA packets data lengths; and
one or more first-generation downlink OFDMA packets data lengths are synchronized with one or more second generation downlink OFDMA packets data lengths.

13. The access point of claim 11, wherein the processing device is further operable to:
receive, at the AP from the first generation STA, one or more first generation uplink orthogonal frequency-division multiple access (OFDMA) packets in a second duration in the lower frequency segment; and
receive, at the AP from the second generation STA, one or more second generation uplink OFDMA packets in the second duration in the upper frequency segment.

14. The access point of claim 13, wherein:
one or more first-generation uplink OFDMA packets preamble lengths are synchronized with one or more second generation uplink OFDMA packets preamble lengths; and
one or more first-generation uplink OFDMA packets data lengths are synchronized with one or more second generation uplink OFDMA packets data lengths.

15. The access point of claim 11, wherein the processing device is further operable to:
send, from the AP to the second generation STA, one or more second-generation downlink OFDMA packets in a third duration in the lower frequency segment and the upper frequency segment.

16. A method, comprising:
sending, from an access point (AP) to a first-generation station (STA), a first generation beacon in a first duration in a first subset of a first frequency segment;
sending, from the AP to a second-generation STA, a second generation beacon in the first duration in a second subset of a second frequency segment;
receiving, at the AP from the first-generation (STA), a first single user packet in a second duration in the first frequency segment; and
receiving, at the AP from the second-generation STA, a second single user packet in a third duration in the second frequency segment.

17. The method of claim 16, further comprising:
associating, at the AP, the first generation STA to the first frequency segment; and
associating, at the AP, the second generation STA to the second frequency segment.

18. The method of claim 16, further comprising:
sending, from the AP to the AP, a clear-to-send (CTS) to self packet in the second duration in a third subset of the second frequency segment; and
sending, from the AP to the AP, a CTS to self packet in the third duration in a fourth subset of the first frequency segment.

19. The method of claim 16, further comprising:
sending, from the AP to the first generation STA, one or more first-generation downlink orthogonal frequency-division multiple access (OFDMA) packets in a fourth duration in the first frequency segment; and
sending, from the AP to the second generation STA, one or more second-generation downlink OFDMA packets in the fourth duration in the second frequency segment.

20. The method of claim 16, further comprising:
receiving, at the AP from the first generation STA, one or more first generation uplink orthogonal frequency-division multiple access (OFDMA) packets in a fifth duration in the first frequency segment; and
receiving, at the AP from the second generation STA, one or more second generation uplink OFDMA packets in a fifth duration in the second frequency segment.
